(19) United States
(12) Patent Application Publication
(10) Pub. No.: US 2004/0039823 A1
(43) Pub. Date: Feb. 26, 2004

(54) System enabling the establishment of a telnet connection to a remote device not provided with a modem

(76) Inventors: Jean-Francois Le Pennec, Nice (FR); Aurelien Bruno, Nice (FR); Nicolas Grisi, La Colle sur Loup (FR); Jean-Marie Sommerlatt, Vence (FR)

Correspondence Address: Samuel H. Dworetsky, AT&T Corp., PO Box 4110, Middletown, NJ, 07748-4110, US

(21) Appl. No.: 10/628,010

(22) Filed: Jul. 25, 2003

(30) Foreign Application Priority Data
Aug. 26, 2002 (FR) 0210585

(51) Int. Cl. G06F 15/16

(52) U.S. Cl. 709/227; 709/230

(57) ABSTRACT

Data transmission system comprising a help desk workstation (100) provided with the Telnet client function and connected to a Wide Area Network WAN (115) and to the Public Switched Telephone Network PSTN (130), and a Telnet manageable device (120) not provided with a modem and to which the help desk workstation may gain access by using the Telnet protocol. The system comprises a data processing device (110) provided with the proxy function and being connected to the PSTN and to the Telnet manageable device by the intermediary of a Local Area Network LAN (125), the data processing device including proxy means for completing a first Telnet connection with the help desk workstation through the PSTN and for establishing a second Telnet connection with the Telnet manageable device upon receiving a request from the help desk workstation to gain the Telnet access to the Telnet manageable device.

### TECHNICAL FIELD

The present invention relates generally to data transmission systems wherein a help desk workstation can establish a Telnet connection through a data transmission network enabling it to use a telephone line to gain access to an IP device and relates in particular to a system enabling the establishment of a Telnet connection with a remote device not provided with a modem.

### BACKGROUND

In managed network services, a service provider manages the customer equipment such as access routers. It generally can gain access to this equipment via one of the network links or through a dial connection via PSTN or ISDN if such a connection is available on the equipment. The main protocol used to control, configure and manage for this equipment is called Telnet which is pre-installed on several platforms such as windows 95/98/NT/2000/XP and UNIX operating systems. Telnet is a standard protocol that is a kind of remote login function.

For a user, to Telnet to a host or device means to establish a connection through a network to this host or device. This connection is feasible through an IP network directly using the IP address or name of the Host or using the dial number of the IP device. Telnet allows a user to use his telephone line to gain access to and control of a remote PC/Server or any IP device having a dial connection.

Telneting to a computer allows the user to control it directly. When the user telnets into a remote device it is as if he was sitting at a terminal and keyboard directly connected to the system. To do this, the user must have access to an account that he is allowed to use. Usually, an account on the remote host is required to be able to login to it once a connection is established.

Several Telnet programs can be used and some are included in Operating systems such as “Hyperterminal” for Windows platforms. When the program is started, it asks the user for a host. Then the host asks for a login name and password. If the user is registered, and has an account, he will be able to log in.

This explains that the Telnet access to customer located devices is a must for service providers in order to manage these devices. In Broadband Internet, only one connection from the router to the network is provided on low cost routers. It can be for example a native DSL/Cable connection or Ethernet router device. No dial backup or dial port for configuration and maintenance is provided and the only serial port is generally the console port. The console port is an asynchronous serial port that can be used for Telnet but is not well protected by passwords. Adding one modem connection to the router on this console port is expensive insofar as a secure external modem with built-in authentication is required since the port is the console port allowing access without authentication.

When the router is not a managed router but under the user responsibility, there is no problem since the user can manage it either from the LAN side Ethernet port or the console port. But, when a service provider manages the router, it becomes more complex and expensive to use a low cost router due to the additional expensive modem.

Today, an external modem is required on such low cost routers and since the console port is the only port, there is a security issue, which requires using a very secure modem with integrated authentication. An existing alternate solution is to use PCs to access locally attached routers but this remote control can only be done by tools that get full control of the PC such as “Carbon Copy” or “Desktop on-call”. There is a user security issue since, if it is normal for the user to get full PC control, it is not conceivable that a customer allows a provider to do it. Today, there are only tools that give a full control of the operating system of the PC. These tools are very efficient but have several drawbacks, which prevent from using them in this environment. The main drawback is the security since the service provider help desk will have access to the full system of the customer. Generally, a customer does not like to allow access to a PC on which confidential information may be stored. In addition, it is not possible to ensure that no injury will be done by mistake or by people that will gain access to system using the dial port. Another drawback is the overhead and performance impact on the system since the system is no longer under control of the customer.

### SUMMARY OF THE INVENTION

Accordingly, the main object of the invention is to achieve a method and to provide a system wherein a user workstation includes a Telnet proxy function enabling a Telnet connection between a Telnet client and a remote device not provided with a modem.

The invention relates therefore to a data transmission system comprising a help desk workstation provided with the Telnet client function and connected to a Wide Area Network WAN and to the Public Switched Telephone Network PSTN, and a Telnet manageable device not provided with a modem and to which the help desk workstation may gain access by using the Telnet protocol. The system comprises a data processing device provided with the proxy function and being connected to the PSTN and to the Telnet manageable device by the intermediary of a Local Area Network LAN, the data processing device including proxy means for completing a first Telnet connection with the help desk workstation through the PSTN and for establishing a second Telnet connection with the Telnet manageable device upon receiving a request from the help desk workstation to gain the Telnet access to the Telnet manageable device.

### BRIEF DESCRIPTION OF THE INVENTION

The above and other objects, features and advantages of the invention will be better understood by reading the following more particular description of the invention in conjunction with the accompanying drawings wherein:

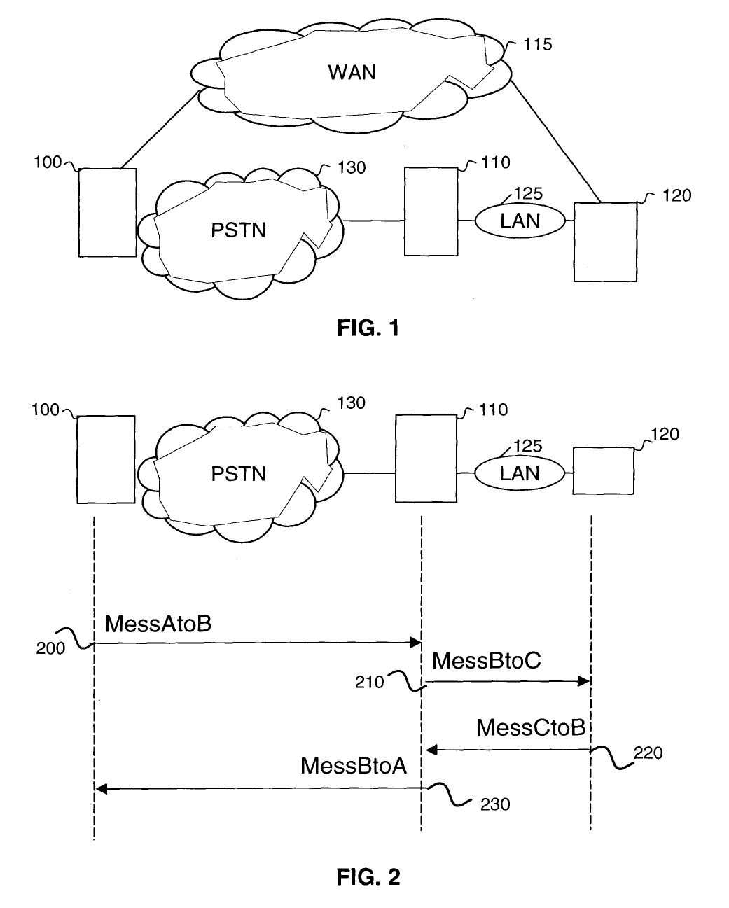

FIG. 1 is a schematic block-diagram representing a system involved in a Telnet environment including the proxy function device according to an embodiment of the invention.

FIG. 2 is a schematic representation of the basic communication flows between the components involved in the system illustrated in FIG. 1.

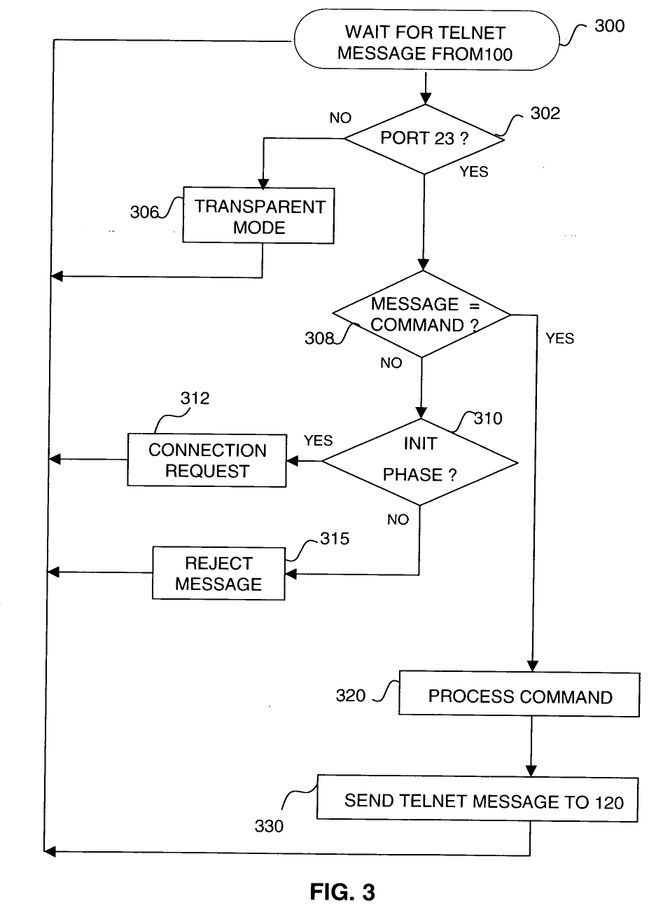

FIG. 3 is a flow chart representing the steps of the method used to establish the connection with a remote device in the system illustrated in FIG. 1.

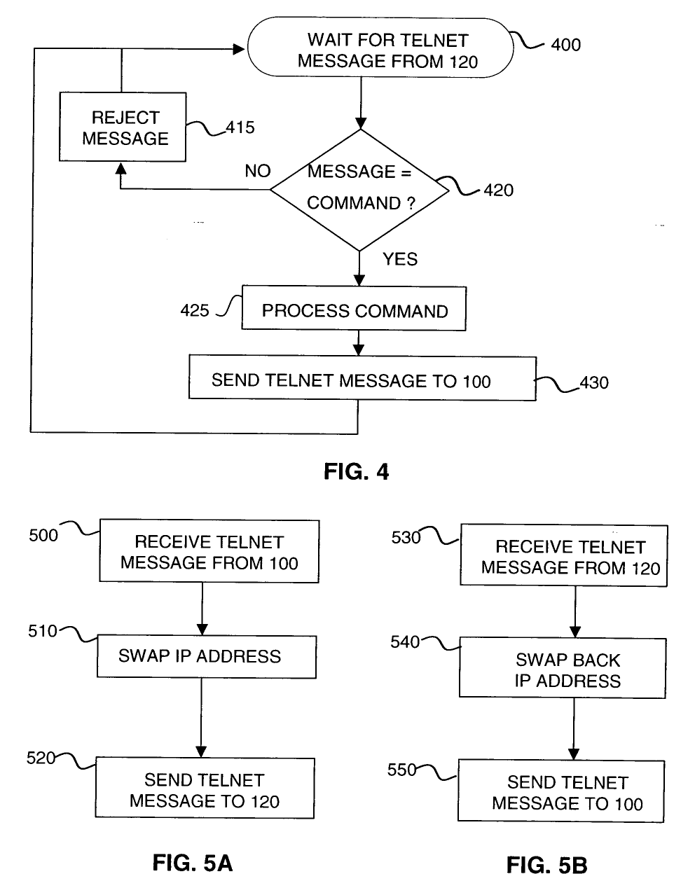

FIG. 4 is a flow chart representing the steps of the method used by the remote device in response to the establishment of the connection.

FIGS. 5A and 5B represent respectively the flow charts of the Telnet command process at the Telnet client and at the remote device.

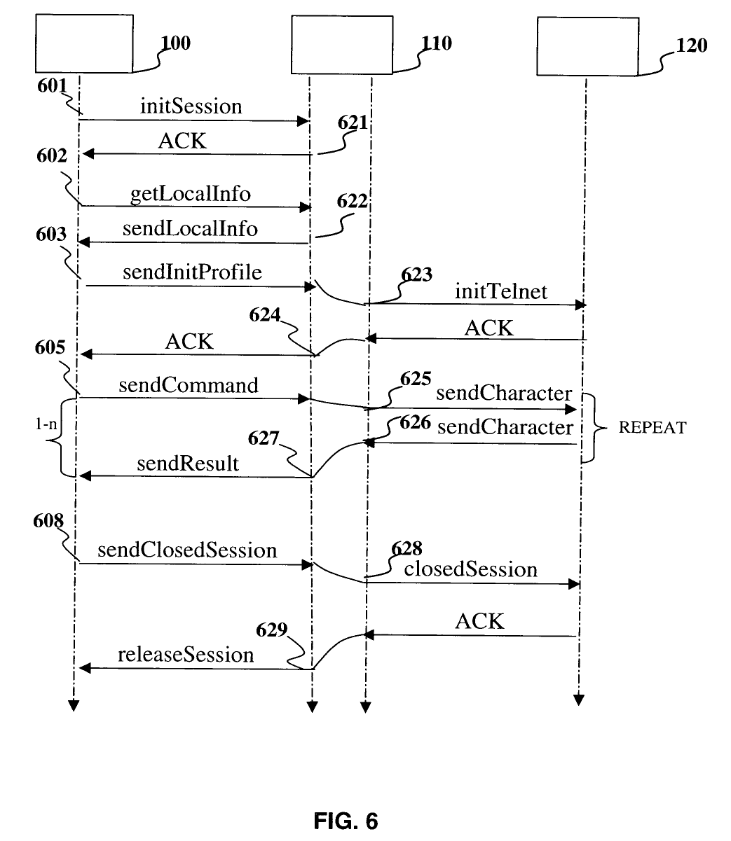

FIG. 6 is a diagram representing the Telnet proxy function flows according to another embodiment of the invention.

### DETAILED DESCRIPTION OF THE INVENTION

The main idea of the invention is to use a user workstation which is a data processing device as a modem to solve the security issue raised by the access of a help desk workstation to the system of the customer as already mentioned. With an additional Telnet proxy function in the PC of the user workstation, this PC will be equivalent to an isolated modem having no access to the user resources. This will allow the connection via a local LAN or via the COM port to the router or, in a general way, to any kind of Telnet manageable device. It is recalled that an application proxy is an application program that runs on a system between two networks. The PC on which the proxy runs does not need to be acting as a router. When a client program establishes a connection “through” a proxy to a destination device, it first establishes a connection directly to the proxy server program. The client then negotiates with the proxy server to make the proxy establish a connection on behalf of the client between the proxy and the destination device. If successful, there are then two connections in place: one between client and the proxy server and another between the proxy server and the destination device. Once established, the proxy then receives and forwards traffic bi-directionally between the Telnet client and the remote device. The proxy makes all connection-establishment and packet-forwarding decisions. Any routing functions that are active on the PC are generally irrelevant to the proxy. In the present invention, the Telnet proxy function is configured for only managing a device such as a router when no direct access is feasible via the Digital Subscriber line (DSL).

In reference to FIG. 1, a help desk workstation 100, which includes the Telnet client function, is connected to the Public Switched Telephone Network (PSTN) 130 and to a WAN 115. Help desk workstation 100 can gain access to a Telnet manageable device 120 through the WAN 115. When this connection fails, an alternate path is required. If no modem is available on device 120, the access to it is then achieved through a data processing device 110 such as an intermediate host or PC on which a Telnet proxy software is implemented. This proxy function is interfaced on the one hand to the modem port 105 connected to PSTN 130 and on the other hand to the port linked to LAN 125 itself connected to the device 120 in the preferred embodiment. It can be also connected to the COM port of the host for rerouting the Telnet commands as explained below. The Telnet proxy function is therefore implemented on top of the IP stack of the host 110 in order to intercept the IP Telnet packets that use IP port 23 which is associated with the Telnet protocol. Therefore, a user on the help desk workstation 100 can reach the PC 110 via the PSTN 130, and then the proxy function in host 110 allows to telnet the remote device 120 to solve problems when the device 120 cannot be reached from the WAN Network side.

Note that two cases are possible. In a first embodiment, the Telnet client 100 is a legacy Telnet client, which conforms to the RFC 854. In that case, the proxy is not configured through the help desk workstation and is preconfigured to access its IP default gateway configured in the host IP stack through the LAN interface or through the serial COM port if it is not reachable via the LAN side.

In a second embodiment, the Telnet client is still a legacy Telnet client. But the proxy is a piece of software that can be user (Host owner) configured to access a defined IP address or list of addresses through the LAN interface or through the serial COM port if it is not reachable via the LAN side.

The main difference between the first and second embodiment is the way the IP address of the device on which the Telnet will be done is preset. The first embodiment uses the default gateway IP address of the Host on which runs the proxy. This default gateway address corresponds to the router to which each IP packet is sent. It can be preconfigured in the host IP configuration or discovered automatically thanks to DHCP (Dynamic Host Configuration Protocol). In SOHO (Small Office Home Office) environment there is generally only one router or possible gateway so that there is no need to define it manually. The second embodiment does not use this default gateway as preferred IP address for Telnet. A file is built in which the IP address is written by the user. The Telnet will be done using this address which may be different from the default gateway defined and used in the Host IP stack. This may be useful in more complex LAN environment where multiple routers are implemented. It is also possible to define more that one IP address in the list, either to access the same device on another port if such interface exists or to gain access to another device when the first fails.

The basic flows used to establish a connection are illustrated in FIG. 2. First, the client program in help desk workstation 100 establishes a legacy telnet connection directly to the proxy server program using messages such as MessAtoB Request 200 and Acknowledgment MessBtoA 230 packets. In parallel, for each packet, the proxy function in host 110 establishes a connection using a set of messages MessBtoC 210 and MessCtoB 220 as answers on behalf of the client between the proxy and the destination device 120 using the same packet type with a different IP header. If successful, there are then two connections in place: one between the client and the proxy function and another between the proxy server and the destination device.

Practically, help desk workstation 100 sends a Telnet “request” message 200 to the Telnet Proxy 110. Then, the Telnet Proxy process stores this message 200 and modifies its IP header in “request” message 210 to forward it to device 120. The device 120 sends a “reply message” 220 to Telnet Proxy 110 which checks, processes and translates back this message in a “reply” message 230 before to send it to the Standard Telnet client 100.

The Telnet proxy method for incoming messages from the Telnet client is now described in reference to FIG. 3. First, the system waits for a telnet message from the help desk workstation (step 300) by scanning the incoming TCP/IP packets on the dial access. When a message arrives, it is checked whether it is received on port 23 associated with the Telnet protocol (step 302). If not, this means that the packet is for another task than the Telnet proxy and the packet is forwarded to the host of the data processing device according a transparent mode (step 306). Note that another Telnet application cannot be used in parallel with the proxy function on the same interface.

If the message is received on port 23, it is checked whether it is a Telnet command (step 308). If not, it is checked whether it corresponds to the phase of initialization for requesting a connection (step 310). If it is not the case, this corresponds to an error and the message is rejected (step 315). If the received message corresponds to the phase of initialization, a connection request is sent to the remote destination device (step 312).

In case of a message complying with the Telnet protocol, it is checked whether it is really a Telnet command (step 320). If not, the message is rejected (step 315). If so, the command is processed (step 325) as described hereafter and a new Telnet message is forwarded to the Telnet manageable device 120 (step 330). Note that, when the message is rejected, a feedback message is sent to the help desk workstation.

In the two first embodiments wherein the Telnet client is a legacy Telnet client, the connection request (step 312) is responsible to

Get the IP address of the device 120,

Get automatically the IP address of LAN interface of device 110, and

Create the Telnet connection between the workstation 100 and the device 110, and between the devices 110 and 120.

But, whereas the IP address of the device 120 corresponds to the default gateway of device 110 in the first embodiment, this IP address has been configured previously in the Telnet proxy program (during the installation for example), in the second embodiment. Note that a rejection message is sent if one of the above steps fails.

FIG. 4 describes the Telnet proxy process for an incoming message from the device 120 to the proxy function in device 110. First, the system waits for a Telnet message from device 120 (step 400). When a message is received, it is checked whether it is a Telnet command on port 23 as previously (step 420), If not, the message is rejected (step 415) and a feedback message is sent to the source. If it is a Telnet command, the command is processed (step 425) as described hereafter, and a new Telnet message is sent to help desk workstation 100 (step 430).

In reference to FIG. 5A, the processing of a command received from help desk workstation 100 starts from step 500 where the Telnet Command process receives a message from workstation 100. This message goes to the SWAP routine 510 which performs the following modifications in the IP Datagram Header:

Change the Source IP address by IP address of host 110,

Change the Destination IP address by IP address of device 120.

Then, the modified Telnet message 520 is sent to device 120.

The processing of a message received from the Telnet manageable device 120 starts in step 530 where the Telnet Command process receives a message from device 120. This message goes to the SWAP BACK routine 540 which performs the following modifications in the IP Datagram Header:

Change the Source IP address by IP address of host 110,

Change the Destination IP address by IP address of workstation 100.

Then, the modified Telnet message 550 is sent to 100.

The need to change the Source and destination IP addresses is because a legacy Telnet client needs to know to which device it connects and be configured for that. As the legacy IP stack of the Host is used, the destination IP address used by the Telnet client is the proxy address. The true destination is in fact the destination device and not the device 110, which acts as a proxy. The proxy, therefore, changes on the fly the destination address with the final device address the proxy knows because it is either the default gateway address or the IP address defined in the proxy configuration. Similarly, the proxy has to change the source address of the packet because the incoming source address is the Telnet client address. To get back an answer from the destination device, the source address has to be the proxy, otherwise the destination address will see an unreachable address.

FIG. 6 shows the flows between involved devices for the more complex solution based on a new Telnet Client that interfaces in a proprietary manner the Telnet proxy function as being referred to a third embodiment of the invention. The advantage of such implementation is to offer better performance and more functionality. The performance increase is due to the aggregation of basic telnet input commands, which is character based into full command messages between the Telnet client 100 and the proxy 110. Then, between host 110 and device 120, the commands are converted back to a character transmission mode.

In addition there is no need to use for telnet between the client and the proxy the IP address of workstation 100 and the IP address of device 110 since a proprietary protocol such as the one detailed hereunder is used. Only the devices 110 and 120 will really exchange telnet messages conforming to the IETF RFC 854 and will use their own IP addresses as source and destination addresses. The proxy in this embodiment does not have to swap the IP addresses for packets transmitted between the workstation and the proxy function because the telnet commands are encapsulated in the proprietary protocol.

The proprietary protocol starts with an InitSession message 601 acknowledged by ACK message 621. Then the settings are exchanged to configure properly the telnet session. This starts by a getLocalInfo message 602 and the answer sendLocalInfo 622, from host 110, which provides the workstation with the environment from the proxy function. Information transmitted may include Interfaces available, IP stack configuration (WinIPcfg or IPconfig in windows), previous Profile used, results of basic host station IP tests such as ping, traceroute, routing information (ROUTE PRINT in windows 2000 for example). Based on this information, the user using the Telnet client will define to which device and through which interface he will issue the Telnet command and therefore configure device 110 thanks to a sendInitProfile message 603 which allows the telnet proxy function to start a real Telnet session with the destination device by initTelnet 623. Upon reception of the acknowledge from device 120, the proxy function will forward the ACK answer 624 to the workstation 100 which means that Telnet commands can be transmitted.

Full lines of commands are sent by the workstation using sendCommand messages 605 that are converted by the proxy into a set of character commands messages 625. A similar process is used for device 120 to transmit commands to the workstation 100 but using the reverse method. Device 120 sends character commands using sendCharacter messages 626 aggregated by the proxy function in order to rebuild full commands forwarded to the workstation 100 as sendResult 627 messages. The proxy function uses a timer for character aggregation, which means that sometimes sendResult contains a partial line command with the remaining part on next messages but it has no impact in the functionality of the system.

Similarly to the Init process, the workstation 100 can initiate a Close session process by sendClosedSession message 608 forwarded to device 120 by the proxy function as ClosedSession 628. The acknowledge message from device 120 allows to release the session by releaseSession message 629 from proxy 110 to workstation 100.

It must be noted that, when the connection through the LAN port has failed, it is possible to use the link from serial asynchronous COM port of host 110 (see FIG. 1) to the console port on device 120. Upon detection of the failure, a retry Telnet connection may be issued by the help desk administration on workstation 100 that will be directed to the COM port of host 110 by the proxy function. An automatic Telnet access attempt through connected COM ports may also be performed after several connection failures via the LAN port if defined within the proxy function. When this is available, the authentication of the user has to be performed within the proxy function of host 110. These options are set during the configuration of the Telnet proxy function.

1. Data transmission system comprising a help desk workstation (100) provided with the Telnet client function and connected to a Wide Area Network WAN (115) and to the Public Switched Telephone Network PSTN (130), and a Telnet manageable device (120) not provided with a modem and to which said help desk workstation may gain access by using the Telnet protocol;
said system being characterized in that it comprises a data processing device (110) provided with the proxy function and being connected to said PSTN and to said Telnet manageable device by the intermediary of a Local Area Network LAN (125), said data processing device including proxy means for completing a first Telnet connection with said help desk workstation through said PSTN and for establishing a second Telnet connection with said Telnet manageable device upon receiving a request from said help desk workstation so that this one can gain the Telnet access to said Telnet manageable device.

2. Data transmission system according to claim 1, wherein said telnet client function corresponds to a legacy Telnet client and wherein said proxy means are adapted to gain access to the default gateway configured in the IP stack of said data processing device upon receiving a request from said help desk workstation.

3. Data transmission system according to claim 1, wherein said Telnet client function corresponds to a legacy Telnet client and wherein said proxy means are adapted to gain access to an IP address in a file including the IP address for the Telnet protocol.

4. Data transmission system according to claim 2 or 3, wherein said proxy means modify the IP address of the request message received from said help desk workstation (100) before sending said request message with the modified IP address to said Telnet manageable device (120).

5. Data transmission system according to any one of claims 1 to 4 wherein said proxy means establish said second connection with said Telnet manageable device (120) through said LAN (125).

6. Data transmission system according to any one of claims 1 to 4, wherein said proxy means establish said connection with said Telnet manageable device (120) through a link from the COM port of said data processing device (110) and the console port of said Telnet manageable device.

7. Data transmission system according to claim 1, wherein said Telnet client function corresponds to a proprietary function adapted to make an encapsulation of the Telnet commands included in the request sent by said help desk workstation (100) to said data processing device (110) including said proxy means, the latter means being adapted to get said Telnet commands from the encapsulated commands received from said desk workstation.

8. Data transmission system according to claim 1, wherein said proxy means are constituted of a program installed in said data processing device.
